(19) United States
(12) Patent Application Publication
(10) Pub. No.: US 2026/0175917 A1
(43) Pub. Date: Jun. 25, 2026

(54) A Roof Rack for a Motor Vehicle

(71) Applicant: RHINO RACK AUSTRALIA PTY LIMITED, Eastern Creek (AU)

(72) Inventors: Nicholas Clarke, New South Wales (AU); Matthew Pummell, New South Wales (AU); Nicolas Spencer, New South Wales (AU)

(21) Appl. No.: 19/124,712

(22) PCT Filed: Oct. 23, 2023
(86) PCT No.: PCT/AU2023/051058

§ 371 Date: Apr. 25, 2025

(30) Foreign Application Priority Data
Oct. 27, 2022 (AU) 2022903180

(51) Int. Cl. B62D 25/06; B60R 9/04; B60R 9/042; B60R 9/045; B60R 9/048; B60R 9/052; B60R 9/058

(52) U.S. Cl. CPC B62D 25/06; B60R 9/04; B60R 9/042; B60R 9/045; B60R 9/048; B60R 9/052; B60R 9/058

(57) ABSTRACT

A roof rack for a motor vehicle is disclosed including: a cargo carrying platform; at least four attachment mechanisms for attaching the platform to a vehicle; wherein each of the attachment mechanisms includes an engagement portion which is arranged to engage around the head region of a door frame of a vehicle.

### TECHNICAL FIELD

This disclosure relates in general to roof racks for motor vehicles.

### BACKGROUND TO THE DISCLOSURE

Roof racks used to carry bulky items such as luggage, bicycles, canoes, kayaks, skis, or various carriers and containers. Roof racks allow users of an automobile to transport objects on the roof of the vehicle without reducing interior space for occupants, or using space in other cargo areas, such as the boot or trunk of a vehicle.

In order to fit a roof rack to many vehicles it is necessary to attach mounting points of the roof rack to the roof of the vehicle. The mounting points are attached with bolt fasteners or rivets which are inserted through the roof panel of the vehicle. To gain access to fit the fasteners it is typically necessary to remove the interior ceiling trim of the vehicle in the car to gain access to the inside of the roof panel. This operation may necessitate removal of a large amount of associated interior trim, sometimes including the rear seats of the vehicle. In addition, if no pre-prepared holes are provided in the roof panel, it is also necessary to drill holes through roof panel to receive the fasteners.

The operation of fitting the roof rack requires skilled operators, and also brings risks of causing damage to parts of the vehicle. In addition, the drilling of holes in the roof panel can affect the structural integrity of the roof and may also negatively affect the resale value of the vehicle. Drilling holes in the roof is a modification to the vehicle which would be best avoided.

There remains a need to provide improved techniques for attaching roof racks to vehicles.

### SUMMARY OF THE DISCLOSURE

In a first aspect the present disclosure provides a roof rack for a motor vehicle including: a cargo carrying platform; at least four attachment mechanisms for attaching the platform to a vehicle; wherein each of the attachment mechanisms includes an engagement portion which is arranged to engage around the head region of a door frame of a vehicle.

Each of the engagement portions may be provided in the form of a hook shaped portion of a bracket.

Each attachment mechanism may include at least one threaded fastener which can be rotated to effect the engagement of the engagement portion with the head region of the door frame.

The at least one threaded fastener may be received in a threaded hole provided in a rotatable member which is free to rotates in an axis which lies generally parallel to a direction along the length of the platform.

Each attachment mechanism may include a pair of threaded fasteners which are received in threaded holes in the rotatable member.

Each of the attachment mechanisms may include a removable cover which obstructs access to the at least one threaded fastener.

Each removable cover may include a locking means to prevent unauthorised removal of the cover.

Each removable cover may include an internal formation which prevents rotation of the at least one threaded fastener whilst the cover is affixed in use to its respective attachment mechanism.

At least one of the attachment mechanisms may include a region of resilient material which in use bears against the upper surface of the roof of a vehicle.

The resilient region may be shaped to engage with a channel provided in the upper surface of the roof of a vehicle.

At least two attachment mechanisms may be provided along each side of the platform and align with each other in a direction across the platform.

Each attachment mechanism may include a leg which is affixed to a panel which extends along the edge of each side of the platform.

The panel may be formed of a lightweight material.

Each leg may include an engagement formation provided at an upper region of the leg to engage the platform to the leg.

In a second aspect the disclosure provides a motor vehicle fitted with a roof rack according to the first aspect of the invention.

The bracket members may be hooked around overhanging regions of the door frames of the vehicle.

The resilient regions of the clamping arrangements may be located within channels provided in the upper surface of the roof of the vehicle.

### BRIEF DESCRIPTION OF THE DRAWINGS

Embodiments will now be described, by way of example only, with reference to the accompanying drawings, in which:

FIG. 1 is a perspective view of a roof rack;

FIG. 2 is an underside view of the roof rack of FIG. 1;

FIG. 3 is a side view of the roof rack of FIG. 1;

FIG. 4 is a front view of the roof rack of FIG. 1;

FIG. 5 shows a mounting assembly and partial view of a side member of the roof rack of FIG. 1;

FIGS. 6 and 7 show the mounting assembly and side member of FIG. 5 with cover removed;

FIG. 8 is c cross sectional view of the mounting assembly of FIG. 5 being engaged with the head of a door frame of a vehicle;

FIG. 9 is a side view of the roof rack of FIG. 1 attached to a vehicle with covers removed;

FIG. 10 is a perspective view of the side panel and legs of a second embodiment of a roof rack;

FIG. 11 is a reverse partially exploded view of the attachment mechanism used with the side panel of FIG. 10;

FIG. 12 is a front partially exploded view of the attachment mechanism of FIG. 9; and

FIG. 13 is an internal view of the cover of the attachment mechanism of FIG. 11 with the clamp omitted.

### DETAILED DESCRIPTION OF EMBODIMENTS

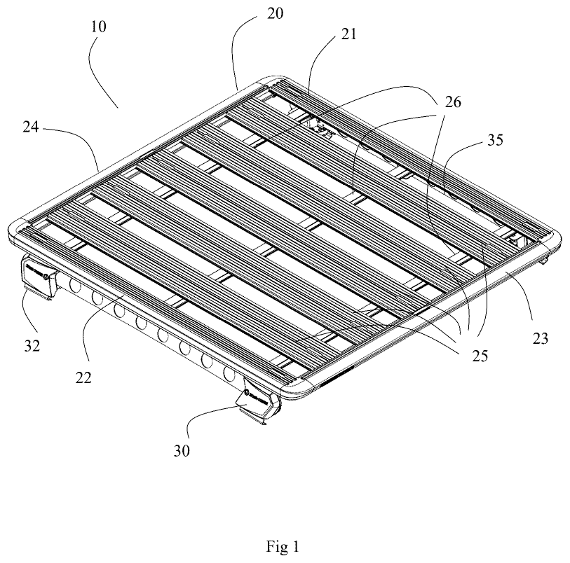

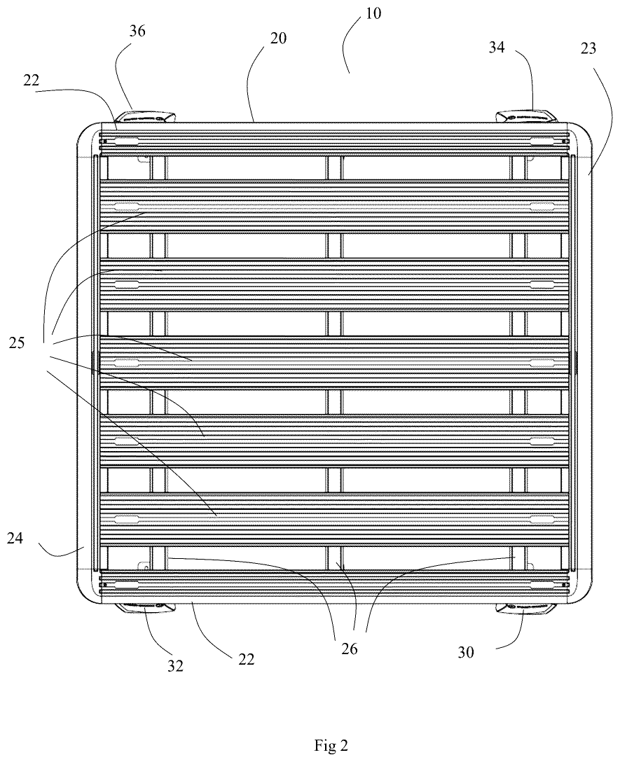

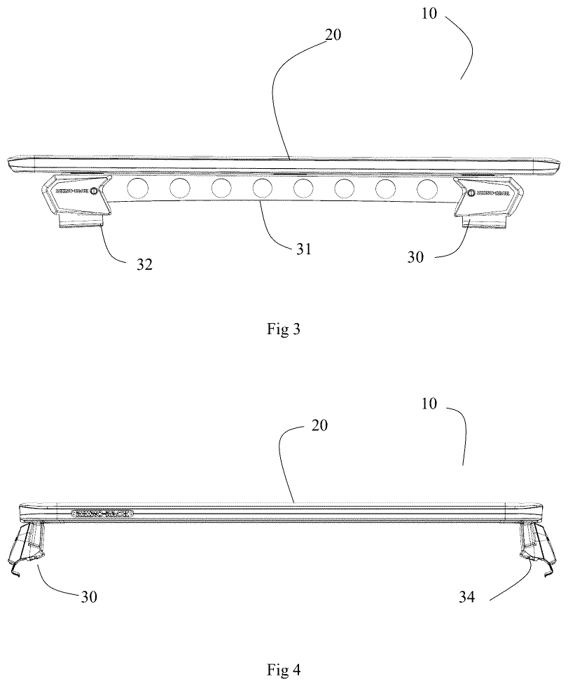

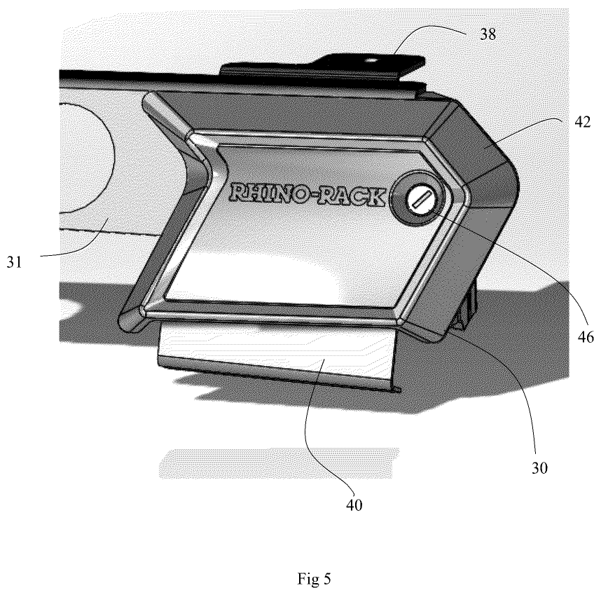

Referring to FIGS. 1 to 4, a roof rack 10 for a motor vehicle is shown including a rectangular cargo carrying platform 20. Platform 20 is formed from a number of aluminium extruded sections including side rails 21, 22, front rail 23, rear rail 24, running planks 25 and under rails 26. The aluminium extruded sections are secured together by steel bolts (not visible) in the locations where they overlie one another. The side rails 21, 22 and front 23 and rear 24 rails are joined where they meet at their ends by nylon reinforced corner mouldings. This construction provides a rigid and lightweight cargo carrying platform 20. In other embodiments the corner pieces may be formed from cast aluminium or an alternate polymer material.

Roof rack 10 further includes four attachment mechanisms in the form of mounting assemblies 30, 32, 34, 36. Mounting assemblies 30, 32 are provided at either end of side member 31. Mounting assemblies 34, 36 are provided at either end of a correspondingly shaped side bracket 35 (partially visible in FIG. 1).

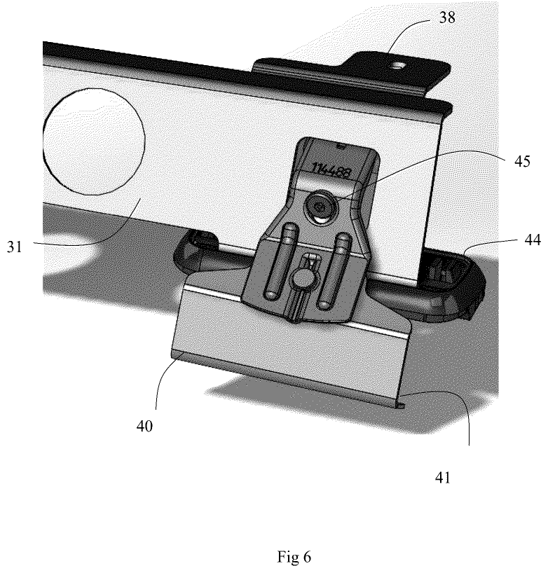

Referring to FIG. 5, mounting assembly 30 is shown in conjunction with side member 31. Side member 31 includes bent over portions 38 (only one visible) which are provided with a through hole for attaching the side member to the underside of platform 20 with bolts. Mounting assembly 30 includes a bracket 40 and a moulded cover 42 overlies the bracket. The cover is locked in place using lock barrel 46. When the lock barrel is in the unlocked condition, the cover 42 can be removed.

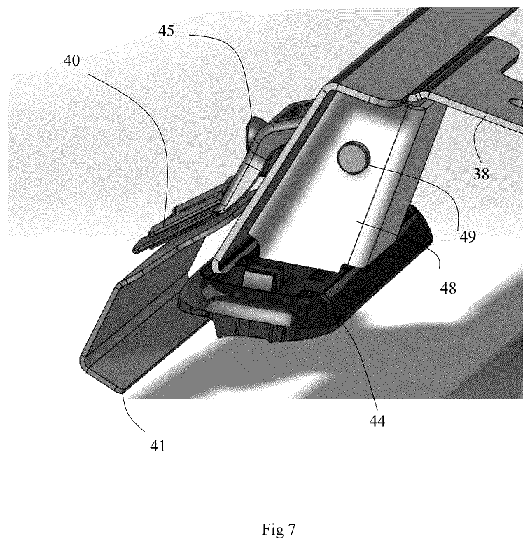

Referring to FIGS. 6 and 7, cover 42 has been removed. Bracket 40 includes a hook shaped engagement portion 41 which in use engages around the head region of a door frame of a vehicle as will be described. Bracket 40 is attached to leg 48 by way of a bolt fastener 45 which engages with a thread formed in a dowel 49 which is rotatably mounted in leg 48. The leg 48, bracket 40 and side member 31 are formed from mild steel and each leg 48 is welded to the side member 31. The fastener 45 and dowel 49 from stainless steel. A region of resilient material is provided in the form of a rubber shoe 44 which is shaped to locate within a channel provided in the roof panel of a vehicle as will be described.

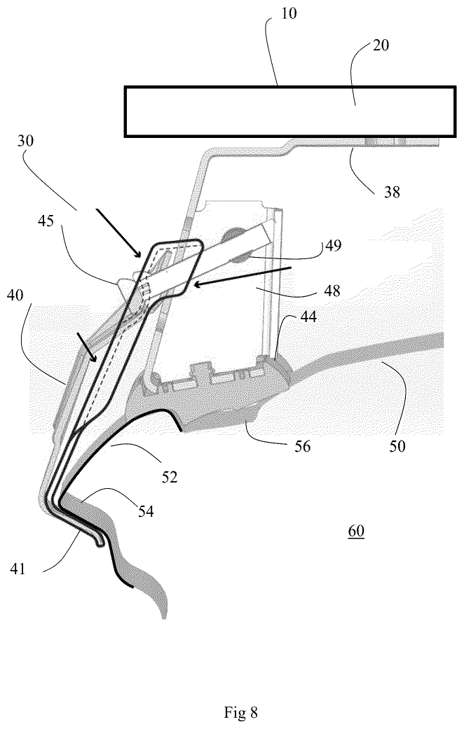

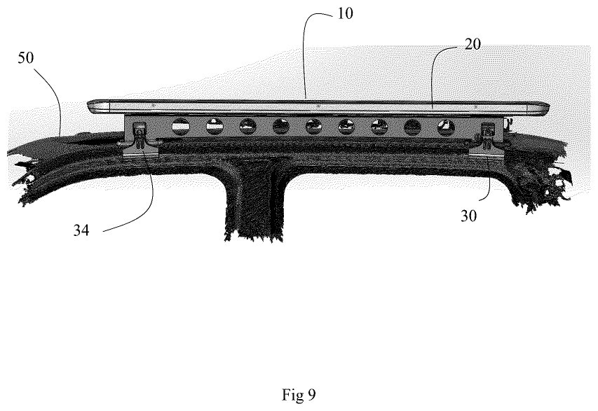

The operation of fitting roof rack to a four door motor vehicle 60 will now be described with reference to FIGS. 8 and 9. Firstly, the roof rack 10 is assembled and prepared for installation by loosening the fours screw fasteners 45 (one at each mounting assembly-only one of which is shown in FIG. 8). Roof rack 10 is then set on top of the roof 50 of the vehicle 60 so that the shoes 44 locate within channels 56 formed in the roof of the vehicle, and so that each of the brackets 40 (one at each mounting assembly) engages with the head region 52 of a door frame of the vehicle so that hook region 41 hooks around the overhanging region 54 of the head of the door frame. Mounting assemblies 30, 32 engage with the door frames of the front doors of the vehicle. Mounting assemblies 34, 36 engage with the door frames of the rear doors of the vehicle.

Each of the four screw fasteners 45 are then progressively tightened in turn up to a specified torque by rotating the fasteners using a suitable tool. The tightening of the bolts 45 draws the bracket 40 inwardly and upwardly towards the leg 48. As the screws 45 are tightened, the bracket 40 elastically deforms to set up a clamping force between the hook region 41 and the overhanging region 54, and also between the shoe 45 and the upper surface of the roof in the region of channel 55. The resilient shoes 44 generate a high friction force to prevent movement of the roof rack 10 in use. They also protect the roof 50 of the vehicle from damage in the region where the shoes 44 press against the roof.

Bracket 40 and shoe 44 are selected with geometries dimensioned to suit a particular shape of vehicle. When fastener 45 reaches the specified torque, the bracket 40 has elastically deformed into a desired final shape which neatly conforms to the profile of the door frame, with the hook portion 41 lying substantially parallel with the outside surface of the overhanding region 54. The brackets 40 do not interfere with the operation of the doors or their door seals in their respective door frames.

The covers 42 may then be applied to each mounting assembly to obstruct access to the head of the screw fastener, and are locked in place to prevent subsequent unauthorised removal of the roof rack. Roof rack 10 is now securely fitted to the vehicle for use.

The clamping forces of the mounting assemblies against the door frames is transmitted across the roof rack, putting the platform assembly 20 into tension. That is to say, the clamping force at mounting assembly 30 is opposed by the oppositely directed force at assembly 34 located on the other side of the vehicle. Similarly, the clamping force at the bracket of assembly 32 is opposed by its opposing assembly 36.

Should it ever be desired to remove the roof rack then this is accomplished by the reverse procedure to that described above. The covers 42 are unlocked and removed, and the fasteners 45 are loosened to allow disengagement of the brackets 40 and the roof rack can be lifted from the vehicle. The procedures of fitting and removing the roof rack are quick to accomplish and require no modifications to be made to the vehicle.

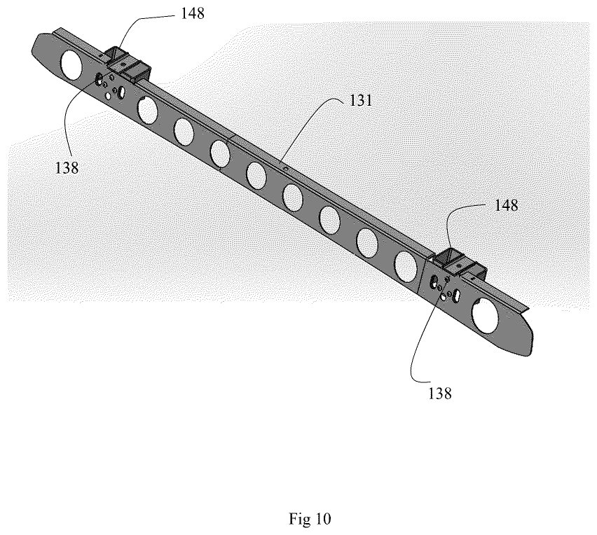

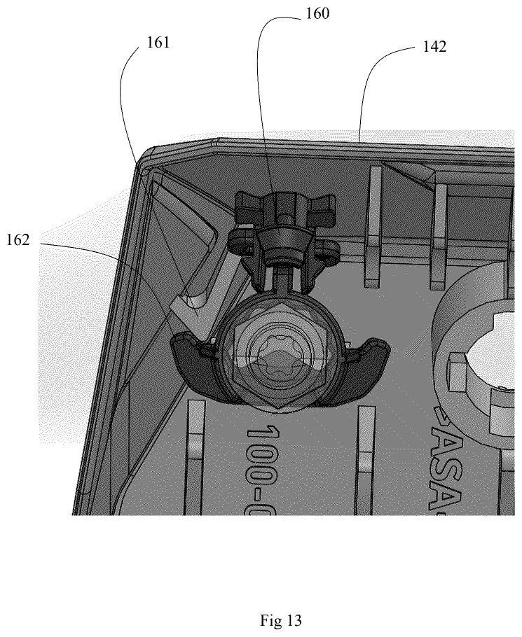

Referring now to FIGS. 10 to 13 an alternative embodiment will be described which includes various modifications to the mounting assemblies of the roof rack to provide for weight savings, improved stability and manufacturing efficiencies. Like reference numerals will be used to describe like features to the first described embodiment in the range 100 to 199.

Referring to FIG. 10, a modified side member 131 is shown to which are attached two legs 148. The legs 148 are formed by laser cutting them from a length of box section which may be formed from steel. The legs 148 are attached to the side member 131 by riveting. Each leg includes an inlay 138 at the top of the leg for attaching and supporting the overhead platform (not shown). In this embodiment, the side panel 131 is non-weight bearing and is formed from a lightweight material such as aluminium or a carbon fibre based material which enables the weight of the overall platform assembly to be minimised.

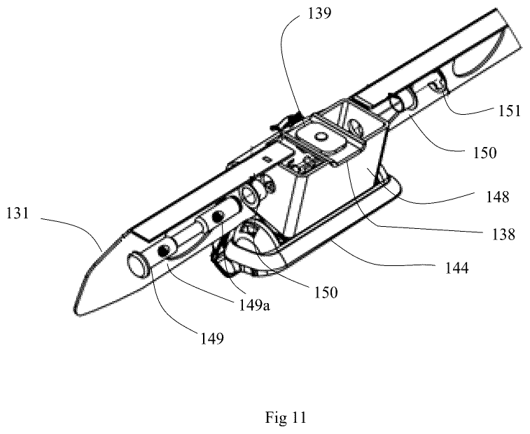

Referring to FIG. 11, a dowel 149 which includes two threaded holes 149a is rotatably mounted in leg 148 by a pair of HDPE bushes 150 and is secured by a circlip 151. A flat retaining piece 139 sits in inlay 138 and in use is received in a channel which has a slot like opening which faces downwordly of the platform. A threaded shaft extends downwards from the retaining piece 139 and is secured by a nut which is used to clamp the platform to between the retaining piece 139 and the inlay 138 to retain the platform on the leg 148.

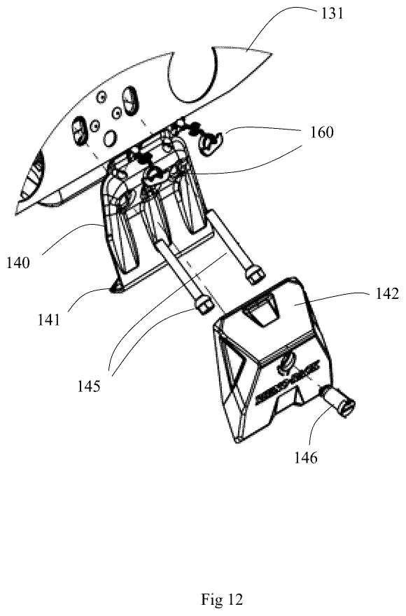

Referring to FIG. 12, two threaded fasteners 145 pass through corresponding holes in clamp 140 and then are received in the threaded holes 149a provided in the dowel 149. By tightening the fasteners 149, the lip 141 of the clamp 140 is brought to bear around the head region of a door of the vehicle to fasten the roof rack assembly to the vehicle.

After tightening the fasteners 145, two anti-rotation clips 160 are attached at one end to the clamp 140 and at their other end they fit around the heads of each of the fasteners 149. In this embodiment a cover 142 is applied to the clamp. Cover 142 is held in place by locking with a keyed lock barrel 146.

Using two fasteners instead of a single fastener as seen in the first described embodiment has been found to constrain the clamps better and prevent them rocking fore/aft when viewed from the side. This prevents the system from shuffling forwards or backwards during vibration.

The cover 142 has a dual function. Firstly, it obstructs access to the heads of the fasteners 145 to prevent unauthorised persons from gaining access to remove the roof rack assembly from the vehicle. Secondly, as illustrated in FIG. 12, a rib 161 provided on the inside surface of the cover 142 engages with a wing 162 of the anti-rotation clip 160 to prevent the clip and thus the fastener 145 from rotating. There is also another rib provided on the inside of the cover which is obscured by the anti-rotation clip which prevents the clip from moving in an outward direction and coming off the head of the fastener 145.

In the second described embodiment, the cover 142 is of identical shape at each attachment mechanism thus reducing the inventory of parts required and reducing tooling costs for manufacturing.

In the embodiments described above the vehicle roof included a channel. Some vehicle roof sections may not contain a channel and in these cases the shoe may sit on a consistent profile or next to a ridged section of the roof.

It can be seen that embodiments have at least one of the following advantages:
A roof rack can be installed on a vehicle without the need to remove the interior trim of the vehicle and without the need to drill holes in the roof of the vehicle.
Fitting and removal procedures are quick to accomplish and can be carried out by an end user without specialised tools or knowledge.

While the disclosure has been described with reference to exemplary preferred embodiments above, it will be appreciated by those of ordinary skilled in the art that it is not limited to those embodiments, but may be embodied in many other forms, variations and modifications other than those specifically described. This disclosure includes all such variation and modifications. The disclosure also includes all of the steps, features, components and/or devices referred to or indicated in the specification, individually or collectively and any and all suitable combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description and apply throughout. Unless otherwise defined, all other scientific and technical terms used herein have the same meaning as commonly understood to one of ordinary skill in the art to which the disclosure belongs.

Any promises made in the present document should be understood to relate to some embodiments of the disclosure, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

In the foregoing description of certain embodiments, specific terminology has been resorted to for the sake of clarity. However, the disclosure is not intended to be limited to the specific terms so selected, and it is to be understood that a specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A roof rack for a vehicle, the roof rack comprising:
a cargo carrying platform; and
at least four attachment mechanisms for attaching the platform to the vehicle, wherein:
each of the attachment mechanisms includes an engagement portion that engages around an upper door jamb of a door frame of the vehicle;
at least two attachment mechanisms are provided along each side of the cargo carrying platform and align with each other in a direction across the cargo carrying platform;
each attachment mechanism is affixed to a planar panel which extends along an edge of each side of the cargo carrying platform; and
a planar surface of each planar panel lies in a substantially vertical orientation.

2. The roof rack of claim 1, wherein each of the engagement portions are a hook shaped portion of a bracket.

3. The roof rack of claim 2, wherein each attachment mechanism includes at least one threaded fastener which can be rotated to effect engagement of the engagement portion with a head region of the door frame.

4. The roof rack of claim 3, wherein the at least one threaded fastener is received in a threaded hole of a rotatable member and is free to rotate in an axis which lies generally parallel to a direction along a length of the cargo carrying platform.

5. The roof rack of claim 4, wherein each attachment mechanism includes a pair of threaded fasteners received in threaded holes in the rotatable member.

6. The roof rack of claim 3, wherein each of the attachment mechanisms includes a removable cover which obstructs access to the at least one threaded fastener.

7. The roof rack of claim 6, wherein each removable cover includes a locking means to prevent unauthorised removal of the cover.

8. The roof rack of claim 6, wherein each removable cover includes an internal formation which prevents rotation of the at least one threaded fastener whilst the cover is affixed in use to its respective attachment mechanism.

9. The roof rack of claim 1, wherein at least one of the attachment mechanisms includes a region of resilient material which in use bears against an upper surface of a roof of the vehicle.

10. The roof rack of claim 9, wherein the resilient region is shaped to engage with a channel provided in the upper surface of the roof of the vehicle.

11. The roof rack of claim 1, wherein each attachment mechanism includes a leg.

12. The roof rack of claim 1, wherein the panel is formed of a lightweight material.

13. The roof rack of claim 11, wherein each leg includes an engagement formation provided at an upper region of the leg to engage the cargo carrying platform to the leg.

14. A vehicle fitted with a roof rack, the roof rack comprising:
a cargo carrying platform; and
at least four attachment mechanisms for attaching the platform to the vehicle, wherein:
each of the attachment mechanisms includes an engagement portion that engages around an upper door jamb of a door frame of the vehicle;
at least two attachment mechanisms are provided along each side of the cargo carrying platform and align with each other in a direction across the cargo carrying platform;
each attachment mechanism is affixed to a planar panel which extends along an edge of each side of the cargo carrying platform; and
a planar surface of each planar panel lies in a substantially vertical orientation.

15. The vehicle of claim 14, wherein each attachment mechanism includes a leg, each leg includes an engagement formation provided at an upper region of the leg to engage the cargo carrying platform to the leg, and the engagement formations are hooked around the upper door jambs of the door frames of the vehicle.

16. The vehicle of claim 14, wherein at least one of the attachment mechanisms includes a region of resilient material which in use bears against an upper surface of a roof of the vehicle, and the regions of resilient material of the attachment mechanisms are located within channels provided in the upper surface of the roof of the vehicle.
